(19) United States
(12) Patent Application Publication
(10) Pub. No.: US 2007/0147404 A1
(43) Pub. Date: Jun. 28, 2007

(54) Method and apparatus for policing connections using a leaky bucket algorithm with token bucket queuing

(75) Inventor: Ronald van Haalen, Hengelo (NL)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: Lucent Technologies, Inc.

(21) Appl. No.: 11/318,894

(22) Filed: Dec. 27, 2005

(51) Int. Cl. H04L 12/56; H04L 12/54

(52) U.S. Cl. 370/412; 370/428

(57) ABSTRACT

The invention includes a method and apparatus for performing packet policing by operating an input queue as a leaky bucket queue. The method includes storing a received packet in a shared memory shared by a plurality of input queues and a plurality of output queues, storing a corresponding packet pointer for the packet in one of the plurality of input queues, transferring the packet pointer from the one of the plurality of input queues to one of the plurality of output queues associated with an output port to which the packet is assigned, and transmitting the packet from the output port using the packet pointer. The packet pointer identifies a storage location in the shared memory. The packet pointer is removed from the one of the plurality of output queues and used for retrieving the packet from the shared memory.

### FIELD OF THE INVENTION

The invention relates to the field of communication networks and, more specifically, to connection policing functions.

### BACKGROUND OF THE INVENTION

In existing networks, various protocols (e.g., Transmission Control Protocol (TCP), User Datagram Protocol (UDP), and the like) may be used for communicating over Internet Protocol (IP) networks. In such networks, network bandwidth is often sold using a service level agreement that specifies a peak information rate at which a customer may transmit information across the network. As such, if a customer agrees to pay for transmitting traffic at a particular rate (i.e., peak information rate), the network operator providing delivery of the traffic ensures that the customer does not exceed the peak information rate. In order to enforce the peak information rate, the incoming traffic rate on a port associated with the connection is monitored using a packet policing mechanism.

In existing networks, packet policing mechanisms are typically implemented at network ingress points (i.e., access nodes). The packet policing is generally performed using either a token bucket policing mechanism or a leaky bucket policing mechanism. The policed packets are sent from the access node ingress point to an access node egress point (e.g., one of a plurality of output interfaces) from which the packet is transmitted. In general, the policing function may be implemented using a token bucket policing mechanism or a leaky bucket policing mechanism.

In a token bucket implementation of a packet policing function, upon arrival of a packet, the token bucket determines, according to the provisioned rate, whether to accept the packet (i.e., allow it to pass through) or to drop the packet. If the token bucket has a small bucket size, TCP performance is typically poor. If the token bucket has a large bucket size, large packet bursts are allowed into the network, causing network traffic delays. As such, despite being less expensive than a leaky bucket implementation, the token bucket implementation does not provide optimum TCP throughput.

In a leaky bucket implementation of a packet policing function, upon arrival of a packet, queuing space availability is checked. If there is queuing space available, the packet is buffered for transmission at the provisioned rate. If the queuing space is filled the packet is dropped. In other words, a leaky bucket implementation of a packet policing function requires extensive queuing space for storing packets. As such, although a leaky bucket implementation of a packet policing function optimizes TCP throughput, the extensive queuing space required for maintaining the leaky bucket renders the leaky bucket implementation of the packet policing function cost prohibitive.

### SUMMARY OF THE INVENTION

Various deficiencies in the prior art are addressed through the invention of a method and apparatus for performing packet policing by operating an input queue as a leaky bucket queue. The method includes receiving a packet at an input port, storing the packet in a shared memory shared by a plurality of input queues and a plurality of output queues, storing a packet pointer for the packet in one of the plurality of input queues, transferring the packet pointer from the one of the plurality of input queues to one of the plurality of output queues associated with an output port to which the packet is assigned, and transmitting the packet from the output port using the packet pointer. The packet pointer identifies a storage location in the shared memory. The packet pointer is removed from the one of the plurality of output queues and used for retrieving the packet from the shared memory.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts a high-level block diagram of an access node of the communication network of FIG. 1;

FIG. 3 depicts a flow diagram of a method according to one embodiment of the present invention; and

FIG. 4 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention operates a packet policing function as a leaky bucket packet policing function in accordance with the buffering requirements of a token bucket packet policing function. The present invention includes a modified node architecture such that the packet policing functions operate as leaky buckets packet policing functions without requiring explicit queuing space for each leaky bucket (rather, the queuing space required is the same as that required for normal queuing of packets in a node, e.g., for queuing of packets for token bucket policing functions).

The present invention utilizes virtual queuing (e.g., input virtual queues and output virtual queues) and an associated shared buffer space for operating the packet policing functions as leaky bucket packet policing functions. The shared buffer space is shared by the input queues and the output queues, thereby forming a virtual queue. By using a shared buffer space (shared by the input queues and output queues), the present invention enables the input queues to operate as leaky bucket policing modules (resulting in optimal TCP throughput) using the queuing requirements of a token bucket implementation (resulting in significantly less expensive buffer space than a standard leaky bucket implementation).

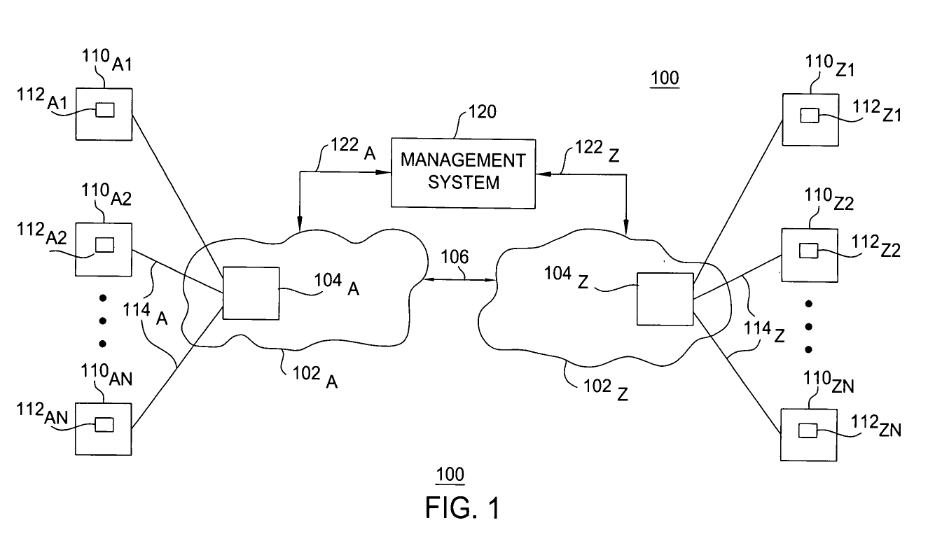

FIG. 1 depicts a high-level block diagram of a communication network architecture. As depicted in FIG. 1, communication network architecture 100 includes a first network 102_{A} including an access node (AN) 104_{A} in communication with a plurality of terminal nodes (TNs) 110_{A1}-110_{AN} (collectively, TNs 110_{A}) using a respectively plurality of access communication links (ACLS) 114_{A}. As depicted in FIG. 1, communication network architecture 100 includes The second network 102_{Z} includes an access node (AN) 104_{Z} in communication with a plurality of terminal nodes (TNs) 110_{Z1}-110_{ZN} (collectively, TNs 110_{Z}) using a respectively plurality of access communication links (ACLs) 114_{Z}. The ANs 104_{A} and 104_{Z} are collectively denoted as ANs 104. The TNs 110_{A} and 110_{Z} are collectively denoted as TNs 110.

As depicted in FIG. 1, networks 102 are operable for supporting communications associated with TNs 110 (e.g., communications between TNs 110, between TNs 110 and various content providers, and the like). For example, networks 102 may be IP networks supporting packet connections (e.g., TCP connections, UDP connections, and the like). Although not depicted, networks 102 include various network elements, communication links, and the like. For purposes of clarity, communications between networks 102 traverse various communication links represented using communication link 106. As such, although not depicted, communication associated with TNs 110, including communication between networks 102, may be performed using various networks, network elements, and associated communication links, as well as various combinations thereof.

As depicted in FIG. 1, TNs 110 include network elements operable for transmitting information and receiving information, as well as displaying various information using at least one display module. In one embodiment, in which networks 102 comprise IP networks, TNs 110 may be IP phones, computers, and the like. In one embodiment, TNs 110 comprise connection endpoints. For a full-duplex connection established for a TN 110, the TN 110 comprises an endpoint of the connection, operating as both a sender and receiver for the connection. The TN 110 operates as a sender of information for the byte-stream transmitted from the TN 110 towards a remote network element. The TN 110 operates as a receiver of information for the byte-stream received by the TN 110 from the remote network element.

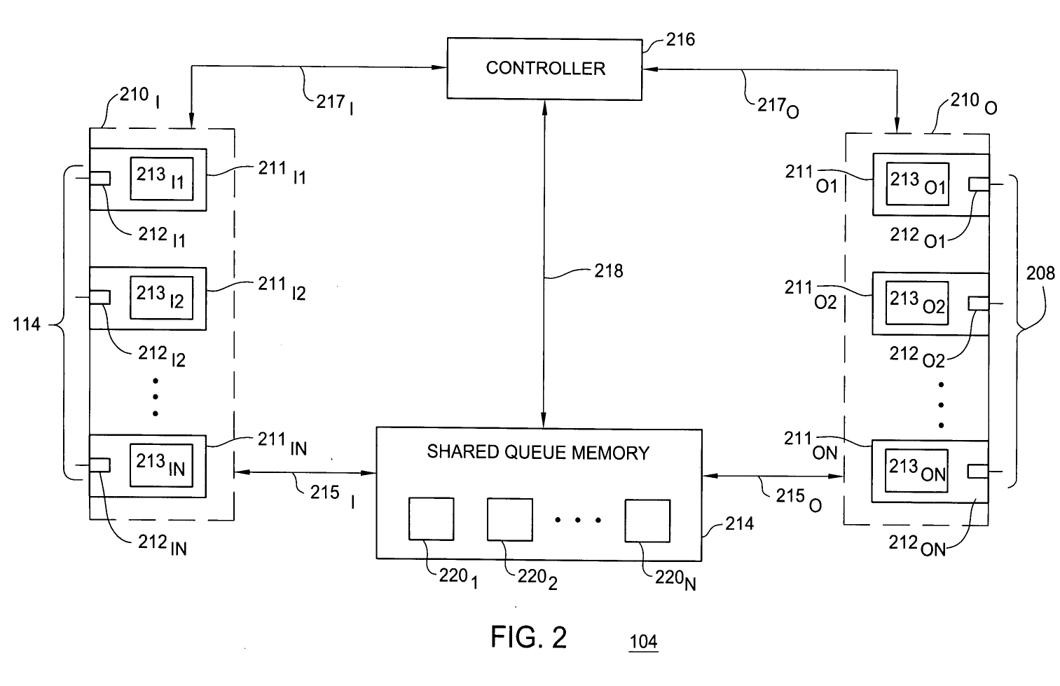

As depicted in FIG. 1, ANs 102 include access nodes operable for supporting communications corresponding to TNs 110 (i.e., receiving various communications from TNs 110 for transmission over corresponding ANs 102 and transmitting various communications towards TNs 110 received over corresponding ANs 102. In one embodiment, in which networks 102 comprise IP networks, ANs 104 may be routers adapted for routing packets (e.g., TCP segments, UDP datagrams, and the like) over IP networks using IP datagrams. Although not depicted, AN 104_{A} includes at least one policing module for policing traffic transmitted from TNs 110_{A} using AN 102_{A} and AN 104_{Z} includes at least one policing module for policing traffic transmitted from TNs 110_{Z} using AN 102_{Z}. As depicted in FIG. 1, ANs 104 may be adapted for performing at least a portion of the functions of the present invention. As such, ANs 104_{A} and 104_{Z} are depicted and described herein with respect to FIG. 2.

As depicted in FIG. 1, a management system (MS) 120 may be deployed for initializing and modifying at least a portion of the policing function parameters utilized by network-based packet policing functions (e.g., packet policing functions implemented on ANs 104). In one embodiment, MS 120 determines a maximum token bucket size and provides the maximum token bucket size to a packet policing module for implementing the determined maximum token bucket size. In another embodiment, in which the maximum token bucket size is determined by an access node, at least a portion of the information used for determining the maximum token bucket size is obtained from MS 120. For example, a peak information rate (PIR) may be obtained from a customer service level agreement (SLA) stored on MS 120. As depicted in FIG. 1, MS 120 communicates with ANs 102_{A} and 102_{Z}, including ANs 104, and, optionally, TNs 110, using management communication links (MCLS) 122_{A} and 122_{Z} (collectively, MCLs 122), respectively.

In one embodiment, at least a portion of the functions of the present invention may be performed by an access node (illustratively, ANs 104). Although not depicted, access nodes in accordance with the present invention may include a plurality of input queues and a plurality of output queues, as well as a shared queue memory shared by the plurality of input queues and the plurality of output queues. The input queues and output queues are adapted for storing packet pointers associated with packets which are stored in the shared queue memory. By storing packets in shared queue memory and storing associated pointers to the packets in the input and output queues, the present invention thereby enables the input queues to operate as leaky bucket packet policing modules while obviating the need for leaky bucket buffer memory. As such, access nodes 104_{A} and 104_{Z} are depicted and described herein with respect to FIG. 2.

FIG. 2 depicts a high-level block diagram of an access node of the communication network architecture 100 of FIG. 1. As depicted in FIG. 2, AN 112 comprises a node input module (NIM) 210_{I} including a plurality of input modules (IMs) 211_{I1}-211_{IN} (collectively, IMs 211_{I}), a node output module (NOM) 210_{O} comprising a plurality of output modules (OMs) 211_{O1}-211_{ON} (collectively, OMs 212_{O}), a shared memory queue (SMQ) 214, and a controller 216. Although the present invention is primarily described herein with respect to a direction of transmission from IMs 211_{I} towards OMs 211_{O}, connections traversing AN 104 may include bidirectional connections (i.e., including a direction of transmission from OMs 211_{O} towards IMs 211_{I}).

As depicted and described herein with respect to FIG. 1, ANs 104_{A} and 104_{Z} receive data from TNs 110_{A} and 110_{Z} using ACLs 114_{A} and 114_{Z}, respectively, and transmit the data towards other nodes of ANs 102_{A} and 102_{Z}, respectively. As such, as depicted in FIG. 2, IMs 211_{I1}-211_{IN} receive data from TNs 110_{A} and 110_{Z} using ACLs 114_{A} and 114_{Z}, respectively, and transmit the data towards the networks 102. Similarly, as depicted and described herein with respect to FIG. 1, ANs 104_{A} and 104_{Z} receive data from ANs 102_{A} and 102_{Z}, respectively, using a plurality of network communication links (NCLs) 208_{A} and 208_{Z} (collectively, NCLs 208), and transmit the data towards TNs 110_{A} and 110_{Z} using ACLs 114_{A} and 114_{Z}, respectively. As such, as depicted in FIG. 2, OMs 211_{O1}-211_{ON} receive data from ANs 102 using NCLs 208, and transmit the data towards TNs 110_{A} and 110_{Z}, respectively.

As depicted in FIG. 2, IMs 211_{I1}-211_{IN} include a plurality of input ports (IPs) 212_{I1}-212_{IN} (collectively, IPs 212_{I}), respectively, and a plurality of input queues (IQs) 213_{I1}-213_{IN} (collectively, IQs 213_{I}), respectively. The IPs 212_{I} are adapted for receiving packets. The IQs 213_{I} are adapted for storing packet pointers associated with packets received by IPs 212_{I}. As depicted in FIG. 2, OMs 211_{O1}-211_{ON} include a plurality of output ports (OPs) 212_{O1}-212_{ON} (collectively, OPs 212_{O}), respectively, and a plurality of output queues (OQs) 213_{O1}-213_{ON} (collectively, OQs 213_{O}), respectively. The OPs 212_{O} are adapted for transmitting packets. The OQs 213_{O} are adapted for storing packet pointers associated with packets transmitted by OPs 212_{O}.

As depicted in FIG. 2, controller 216 communicates with NIM 210_{I} and NOM 210_{O} using respective connections 217_{I} and 217_{O}. Although controller 216 is depicted as communicating with NIM 210_{I} and NOM 210_{O} using single connections, controller 216 communicates with IPs 212_{O} and associated IQs 213_{I} (of NIM 210_{I}) and communicates with OPs 212_{O} and associated OQs 213_{O} (of NOM 210_{O}) individually using respective pluralities of connections which, for purposes of clarity, are represented as connections 217_{I} and 217_{O}, respectively. As depicted in FIG. 2, SQM 214 communicates with NIM 210_{I} and NIM 210_{O} using respective connections 215_{I} and 215_{O}. Although SQM 214 is depicted as communicating with NIM 210_{I} and NOM 210_{O} using single connections, SQM 214 communicates with IPs 212_{I} and associated IQs 213_{I} (of NIM 210_{I}) and communicates with OPs 212_{O} and associated OQs 213_{O} (of NOM 210_{O}) individually using respective pluralities of connections which, for purposes of clarity, are represented as connections 215_{I} and 215_{O}, respectively. As depicted in FIG. 2, controller 216 communicates with SQM 214 using connection 218.

In one embodiment, upon receiving a packet (e.g., from one of the TNs 110), IP 212_{I} (e.g., IP 212_{I2}) receiving the packet signals controller 216 for determining whether SQM 214 has adequate available memory for storing the received packet. If SQM 214 does not have adequate available memory (i.e., available storage space) for storing the received packet, controller 216 signals IP 212_{I} to drop the packet (i.e., the packet is not stored in SQM 214). In one such embodiment, if SQM 214 does have adequate available memory for storing the received packet, controller 216 either forwards the packet to SQM 214 using connection 218 or signals the IP 212_{I} to forward the packet to SQM 214 using connection 215_{I}. In this embodiment, controller 216 generates a packet pointer associated with the stored packet and stores the packet pointer in the IQ 213_{I} associated with IP 212_{I} on which the packet is received.

In one embodiment, upon receiving a packet (e.g., from one of the TNs 110), IP 212_{I} (e.g., IP 212_{I2}) receiving the packet signals controller 216 for determining whether the IQ 213_{I} associated with IP 212_{I} on which the packet is received has adequate available memory (i.e., available storage space) for storing a packet pointer associated with the received packet. If IQ 213_{I} does not have adequate available memory for storing the packet pointer, controller 216 signals IP 212_{I} to drop the packet (i.e., the packet is not stored in SQM 214). In one such embodiment, if IQ 213_{I} does have adequate available memory for storing the packet pointer, controller 216 either forwards the packet to SQM 214 using connection 218 or signals the IP 212_{I} to forward the packet to SQM 214 using connection 215_{I}. In this embodiment, controller 216 generates the packet pointer associated with the stored packet and stores the packet pointer in the IQ 213_{I} associated with IP 212_{I} on which the packet is received.

As depicted in FIG. 2, SQM 214 stores packets received by IPs 212_{I} and transmitted by OPs 212_{O}. In one embodiment, SQM 214 receives packets from controller 216 (from IPs 212_{I}) and transmits packets to controller 216 (for OPs 212_{O}). In one embodiment, SQM 214 receives packets from IPs 212_{I} and transmits packets to OPs 212_{O}. In one embodiment, SQM 214 may be partitioned into a plurality of memory portions (MPs) 220₁-220_{M} (collectively, MPs 220). In one such embodiment, SQM 214 is partitioned using one of a plurality of memory partitioning schemes. For example, SQM 214 may be partitioned such that each MP 220 is associated with one or more of the IQs 213_{I}, such that each MP 220 is associated with one or more of the OQs 213_{O}, or such that each MP 220 is associated with a combination of one or more of the IQs 213_{I} and one or more of the OQs 213_{O}, as well as various combinations thereof. In one embodiment, partitioning of SQM 214 is performed by controller 216.

As depicted in FIG. 2, OQs 213_{O} include queues adapted for receiving and storing packet pointers. The OQs 213_{O} store packet pointers associated with packets assigned for transmission from respective OPs 212_{O} associated with OQs 213_{O} (e.g., OQ 213_{O2} stores a packet pointer for a packet assigned for transmission from OP 212_{O2}). In one embodiment, OQs 213_{O} receive packet pointers from IQs 213_{I} using connections (which, for purposes of clarity, are not depicted) between IQs 213_{I} and OQs 213_{O}. In one embodiment, OQs 213_{O} receive packet pointers from controller 216 (i.e., controller 216 propagates packet pointers from IQs 213_{I} to OQs 213_{O} using connections 217_{I} and 217_{O}. In such embodiments, in which IQs 213 operate as leaky bucket queues, IQs 213_{I} provide packet pointers to OQs 213_{O} in a manner for maintaining an information rate (e.g., a configured peak information rate).

In one embodiment, information rates associated with IQs 213_{I} are maintained by IQs 213_{I}. In one embodiment, information rates associated with IQs 213_{I} are maintained by IQs 213_{I} using various control signals from controller 216. In one such embodiment, OQs 213_{O} receive packet pointers from IQs 213_{I} in response to a pointer transfer signals transmitted from controller 216 to IQs 213_{I} instructing IQs 213_{I} to transfer the packet pointers to the respective OQs 213_{O} to which the associated packets are assigned for transmission. Although described with respect to specific information rate policing mechanism, various other information rate policing mechanisms may be used in accordance with the present invention.

As depicted in FIG. 2, OPs 212_{O} include ports adapted for transmitting stored packets. In one embodiment, OPs 212_{O} receive stored packets (for transmission toward other nodes) from SQM 214. In one embodiment, OPs 212_{O} receive stored packets (for transmission toward other nodes) from controller 216. In such embodiments, the stored packets are extracted from SQM 214 for transmission by OPs 212_{O} in response to respective determinations that the stored packets are scheduled to be transmitted (e.g., packet pointers associated with the stored packets are extracted from the corresponding OQs 213_{O}). In one embodiment, in which OQs 213_{O} are implemented as first-in-first-out (FIFO) queues, packet pointers associated with stored packets are extracted from OQs 213_{O} as the packet pointers reach the respective fronts of OQs 213_{O}.

Although described with respect to specific mechanisms for transferring received packets between IPs 212_{I} and SQM 214 for storing the received packets, various other packet transfer mechanisms may be used in accordance with the present invention. Although described with respect to specific mechanisms for transferring stored packets between SQM 214 and OPs 212₂ for transmitting the stored packets, various other packet transfer mechanisms may be used in accordance with the present invention. Although described with respect to specific mechanisms for transferring packet pointers between IQs 213_{I} and OQs 213O, various other packet pointer transfer mechanisms may be used in accordance with the present invention.

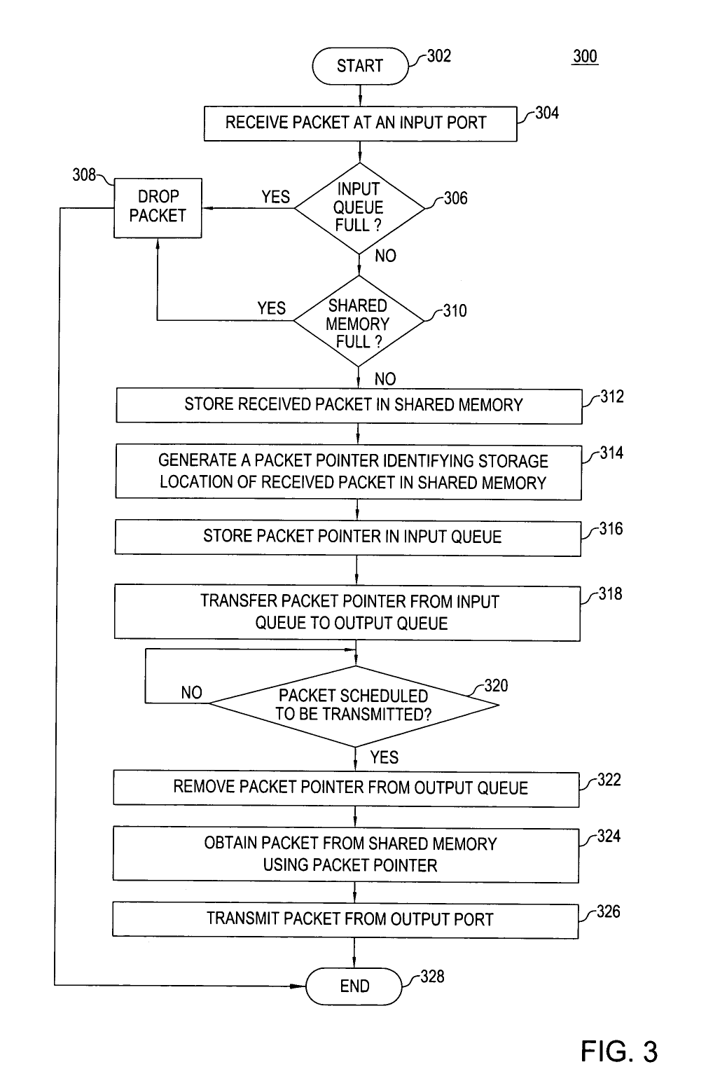

As depicted in FIG. 2, controller 216 controls operation of IMs 211_{I} (including IPs 212_{I} and IQs 213_{I}), OMs 211_{O} (including OPs 212_{O} and OQs 213_{O}), and SQM 214. In one embodiment, controller 216 controls receiving of packets to IPs 212_{I} and transmitting of packets from OPs 212_{O}. In one embodiment, controller 216 controls transfer of received packets from IPs 212_{I} to SQM 214, storage of packets in SQM 214, and transfer of stored packets from SQM 214 to OPs 212_{O}. In one embodiment, controller 216 controls packet pointer generation. In one embodiment, controller 216 controls transfer of packet pointers from IQs 213_{I} to OQs 213_{O}. As such, IMs 211_{I}, SQM 214, and OMs 211_{O}, in conjunction with controller 216, provide at least a portion of the functions of the present invention. A method according to one embodiment of the present invention is depicted and described herein with respect to FIG. 3.

FIG. 3 depicts a flow diagram of a method according to one embodiment of the invention. Specifically, method 300 of FIG. 3 comprises a method for operating an input queue as a leaky bucket queue using a shared queue memory (i.e., shared by a plurality of input queues and a plurality of output queues). Although depicted as being performed serially, those skilled in the art will appreciate that at least a portion of the steps of method 300 may be performed contemporaneously, or in a different order than presented in FIG. 3. The method 300 begins at step 302 and proceeds to step 304.

At step 304, a packet is received at an input port. At step 306, a determination is made as to whether an input queue associated with the input port is full. If the input queue is full, method 300 proceeds to step 308, at which point the packet is dropped. The method 300 then proceeds to step 330, where method 300 ends. If the input queue is not full, method 300 proceeds to step 310. At step 310, a determination is made as to whether the shared memory is full. If the shared memory is full, method 300 proceeds to step 308, at which point the packet is dropped. The method 300 then proceeds to step 328, where method 300 ends. If the shared memory is not full, method 300 proceeds to step 312.

At step 312, the received packet is stored in the shared memory. At step 314, a packet pointer is generated. The generated packet pointer identifies the storage location of the received packet in the shared memory. At step 316, the packet pointer is stored in the input queue. At step 320, the packet pointer is moved from the input queue to the output queue. The packet pointer is moved to the output queue associated with the output port to which the packet is assigned for transmission. In one embodiment, the packet pointer is moved from the input queue to the output queue in accordance with an information rate (e.g., a peak information rate policed by the input queue).

At step 320, a determination is made as to whether the packet is scheduled to be transmitted. If the packet is not scheduled to be transmitted, method 300 loops within step 320 until the packet is scheduled to be transmitted. If the packet is scheduled to be transmitted, method 300 proceeds to step 322. At step 322, the packet pointer is removed from the output queue. At step 324, the packet is retrieved from the shared memory using the packet pointer. At step 326, the retrieved packet is transmitted from the output port towards a downstream network element. The method 300 then proceeds to step 328, where method 300 ends.

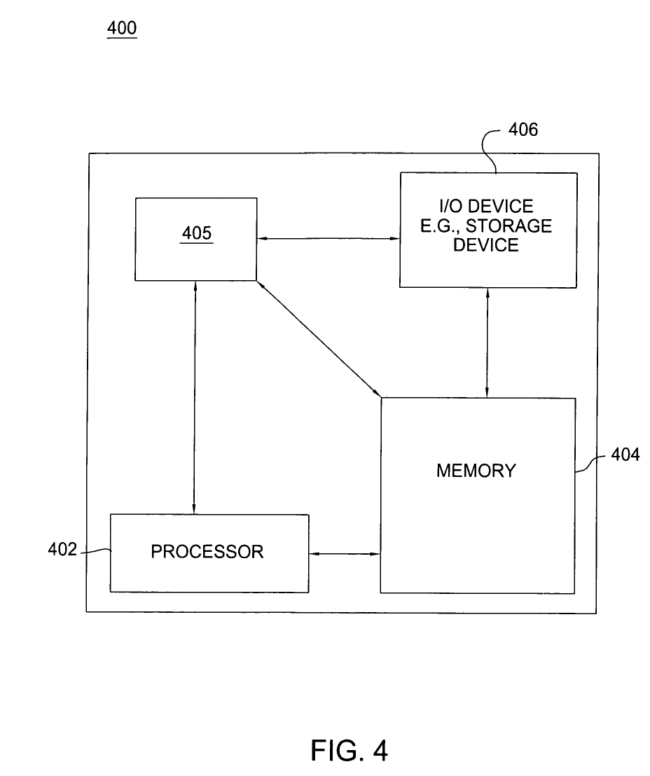

FIG. 4 depicts a high-level block diagram of a general purpose computer suitable for use in performing the functions described herein. As depicted in FIG. 4, system 400 comprises a processor element 402 (e.g., a CPU), a memory 404, e.g., random access memory (RAM) and/or read only memory (ROM), a packet policing module 405, and various input/output devices 406 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present packet policing module or process 405 can be loaded into memory 404 and executed by processor 402 to implement the functions as discussed above. As such, packet policing process 405 (including associated data structures) of the present invention can be stored on a computer readable medium or carrier, e.g., RAM memory, magnetic or optical drive or diskette and the like.

Although various embodiments which incorporate the teachings of the present invention have been shown and described in detail herein, those skilled in the art can readily devise many other varied embodiments that still incorporate these teachings.

What is claimed is:

1. A method for performing packet policing, comprising:
storing a received packet in a memory shared by a plurality of input and output queues;
storing a corresponding packet pointer in an input queue, the packet pointer identifying a storage location of the packet in the shared memory;
transferring the packet pointer from the input queue to an output queue associated with an output port to which the packet is assigned; and
transmitting the packet from the output port using the packet pointer.

2. The method of claim 1, wherein storing the packet in the shared memory comprises:
determining whether the input queue has available storage space;
determining whether the shared memory has available storage space; and
storing the packet in the shared memory in response to a determination that both the input queue and the shared memory have available storage space.

3. The method of claim 1, wherein storing the packet in the shared memory comprises:
determining an available storage space of the shared memory; and
storing the packet in the shared memory in response to a determination that the available storage space of the shared memory is sufficient for storing the packet.

4. The method of claim 1, wherein storing the packet in the shared memory comprises:
determining an available storage space of a portion of the shared memory, the portion of the shared memory associated with the input queue and the output queue; and
storing the packet in the portion of the shared memory in response to a determination that the available storage space of the portion of the shared memory is sufficient for storing the packet.

5. The method of claim 1, wherein storing the packet pointer for the packet comprises:
generating the packet pointer in response to storing the packet in the shared memory; and
storing the packet pointer in the input queue.

6. The method of claim 1, wherein transferring the packet pointer from the input queue to the output queue is performed in accordance with an information rate.

7. The method of claim 1, wherein transferring the packet pointer from the input queue to the output queue is performed in a manner for maintaining the packet in the shared memory.

8. The method of claim 1, wherein transmitting the packet from the output port comprises:
removing the packet pointer from the output queue;
retrieving the packet from the shared memory using the packet pointer; and
transmitting the packet over a communication link associated with the output port.

9. The method of claim 8, wherein the packet pointer is removed from the output queue when the packet is scheduled to be transmitted.

10. An apparatus for performing packet policing, comprising:
means for storing a received packet in a memory shared by a plurality of input and output queues;
means for storing a corresponding packet pointer in an input queue, the packet pointer identifying a storage location of the packet in the shared memory;
means for transferring the packet pointer from the input queue to an output queue associated with an output port to which the packet is assigned; and
means for transmitting the packet from the output port using the packet pointer.

11. The apparatus of claim 10, wherein the means for storing the packet in the shared memory comprises:
means for determining whether the input queue has available storage space;
means for determining whether the shared memory has available storage space; and
means for storing the packet in the shared memory in response to a determination that both the input queue and the shared memory have available storage space.

12. The apparatus of claim 10, wherein the means for storing the packet in the shared memory comprises:
means for determining an available storage space of the shared memory; and
means for storing the packet in the shared memory in response to a determination that the available storage space of the shared memory is sufficient for storing the packet.

13. The apparatus of claim 10, wherein the means for storing the packet in the shared memory comprises:
means for determining an available storage space of a portion of the shared memory, the portion of the shared memory associated with the input queue and the output queue; and
means for storing the packet in the portion of the shared memory in response to a determination that the available storage space of the portion of the shared memory is sufficient for storing the packet.

14. The apparatus of claim 10, wherein the means for storing the packet pointer for the packet comprises:
means for generating the packet pointer in response to storing the packet in the shared memory; and
means for storing the packet pointer in the input queue.

15. The apparatus of claim 10, wherein the means for transferring the packet pointer from the input queue to the output queue moves the packet pointer in accordance with an information rate.

16. The apparatus of claim 10, wherein the means for transmitting the packet from the output port using the packet pointer comprises:
means for removing the packet pointer from the output queue;
means for retrieving the packet from the shared memory using the packet pointer; and
means for transmitting the packet over a communication link associated with the output port.

17. An apparatus for performing packet policing, comprising:
an input interface comprising an input queue for storing a packet pointer associated with a received packet;
an output interface comprising an output queue for storing a packet pointer associated with a packet transmitted from an output port associated with the output queue; and
a shared memory coupled to the input interface and the output interface and shared by the input queue and the output queue, the shared memory adapted for storing each packet.

18. The apparatus of claim 17, further comprising:
a controller coupled to the input interface, the output interface, and the shared memory, the controller adapted for:
generating the packet pointer for the received packet;
storing the packet pointer in the input queue; and
transferring the packet pointer from the input queue to the output queue in accordance with an information rate.

19. The apparatus of claim 18, wherein the controller is further adapted for:
determining whether the input queue has available storage space;
determining whether the shared memory has available storage space; and
storing the packet in the shared memory in response to a determination that both the input queue and the shared memory have available storage space.

20. The apparatus of claim 19, wherein the controller is further adapted for:
retrieving the packet from the shared memory using the packet pointer in response to removal of the packet pointer from the output queue; and
providing the retrieved packet to the output port associated with the output queue for transmitting the packet over a communication link.
